(19) United States
(12) Patent Application Publication
(10) Pub. No.: US 2018/0304814 A1
(43) Pub. Date: Oct. 25, 2018

(54) REAR VIEW MIRROR-LIKE PERSPECTIVE CHANGE SYSTEM AND METHOD

(71) Applicant: Panasonic Automotive Systems Company of America, Division of Panasonic Corporation of North America, PEACHTREE CITY, GA (US)

(72) Inventor: MICHAEL DEAN TSCHIRHART, ANN ARBOR, MI (US)

(73) Assignee: Panasonic Automotive Systems Company of America, Division of Panasonic Corporation of North America

(21) Appl. No.: 15/956,710

(22) Filed: Apr. 18, 2018

Related U.S. Application Data
(60) Provisional application No. 62/489,105, filed on Apr. 24, 2017.

(51) Int. Cl. B60R 1/02; B60R 1/12

(52) U.S. Cl. CPC B60R 1/02; B60R 2001/1253; B60R 2001/1215; B60R 1/12

(57) ABSTRACT

A motor vehicle has an internal camera capturing first images including at least one eye of a driver of the motor vehicle. An external camera captures second images. The second images are of a scene behind the motor vehicle. An electronic processor is communicatively coupled to both the internal camera and the external camera. The electronic processor determines, based on the first images, a location of the at least one eye of a driver. The electronic processor transmits a video signal representing a selected portion of mirror images of the second images. The portion of the mirror images of the second images that is selected for inclusion in the video signal is dependent upon the determined location of the at least one eye of the driver. A display screen is communicatively coupled to the electronic processor and displays the video signal.

### CROSS-REFERENCED TO RELATED APPLICATIONS

This application claims benefit of U.S. Provisional Application No. 62/489,105 filed on Apr. 24, 2017, which the disclosure of which is hereby incorporated by reference in its entirety for all purposes.

### BACKGROUND OF THE INVENTION

### 1. Field of the Invention

The present invention relates to rearview displays in a motor vehicle, and, more particularly, to display-based mirror substitute technologies.

### 2. Description of the Related Art

Display-based mirror substitute technologies like intelligent rearview mirror system (IRMS) enable a range of desirable features and functions to the driver. However, early testing reveals that such systems are unpleasant and difficult to use for some users because their use is uncomfortably unnatural compared to the use of traditional mirrors. Most systems of this kind rely on a comparatively clumsy, manual adjustment of image coverage through the use of some button- or screen-based interface.

### SUMMARY OF THE INVENTION

The present invention may provide display-based alternatives to the traditional rear-view mirror (e.g., IRMS), and may provide a more natural and desirable functionality to such display-based mirror substitute technologies. The invention may combine information about the driver's eye position with processing capabilities of the IRMS (or related technology) display system to dynamically adjust the gaze perspective to make the experience more naturalistic, as though it behaved like a traditional mirror.

The invention may deliver this functionality using eye- and/or head-tracking to determine the position of the driver in combination with a display-based mirror substitute to dynamically adjust the perspective of the image presented on the display to emulate the effect of the changing viewable image on a mirror as the driver's eyes move. For instance, as the user changes her head position to one side, the display image may adjust to correspond to the viewable area that would be evident with a corresponding change of head position using a traditional mirror.

In one embodiment, the present invention comprises a motor vehicle having an internal camera capturing first images including at least one eye of a driver of the motor vehicle. An external camera captures second images. The second images are of a scene behind the motor vehicle. An electronic processor is communicatively coupled to both the internal camera and the external camera. The electronic processor determines, based on the first images, a location of the at least one eye of a driver. The electronic processor transmits a video signal representing a selected portion of mirror images of the second images. The portion of the mirror images of the second images that is selected for representation by the video signal is dependent upon the determined location of the at least one eye of the driver. A display screen is communicatively coupled to the electronic processor and displays the video signal.

In another embodiment, the present invention comprises a method of providing a display in a motor vehicle. The method includes capturing first images including at least one eye of a driver of the motor vehicle. Second images of a scene behind the motor vehicle are captured. A location of the at least one eye of the driver is determined based on the first images. A portion of mirror images of the second images is selected for inclusion in a video signal. The portion of the mirror images of the second images that is selected is dependent upon the determined location of the at least one eye of the driver. The video signal is transmitted to a display screen. Third images are displayed on the display screen. The third images are based on the video signal.

In yet another embodiment, the present invention comprises a motor vehicle having an internal camera capturing first images including a head of a driver of the motor vehicle. An external camera captures second images of a scene behind the motor vehicle. An electronic processor is communicatively coupled to both the internal camera and the external camera. The electronic processor determines, based on the first images, a location of the head of the driver. A video signal is transmitted based on a selected portion of the second images. The portion of the second images that is selected is dependent upon the determined location of the head of the driver. 4 display screen is communicatively coupled to the electronic processor and displays third images. The third images are based on the video signal.

An advantage of the present invention is that it may dramatically improve natural features of how people want to interact with the technology and further reduce other aspects of product interaction “friction” (e.g., less time, fewer steps, etc.).

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a rearview display arrangement of the present invention.

FIG. 2A is a rear view inside a passenger compartment of a motor vehicle including the rearview display arrangement of FIG. 1.

FIG. 2B is a top view inside a passenger compartment of a motor vehicle including the rearview display arrangement of FIG. 1.

FIG. 3 is a plan view of a field of view of the external camera of the rearview display arrangement of FIG. 1, and the portion of the field of view that is displayed on the display screen of the rearview display arrangement of FIG. 1.

FIG. 4 is a flow chart of one embodiment of a method of the present invention for providing a display in a motor vehicle.

### DETAILED DESCRIPTION OF DRAWINGS

The embodiments hereinafter disclosed are not intended to be exhaustive or limit the invention to the precise forms disclosed in the following description. Rather the embodiments are chosen and described so that others skilled in the art may utilize its teachings.

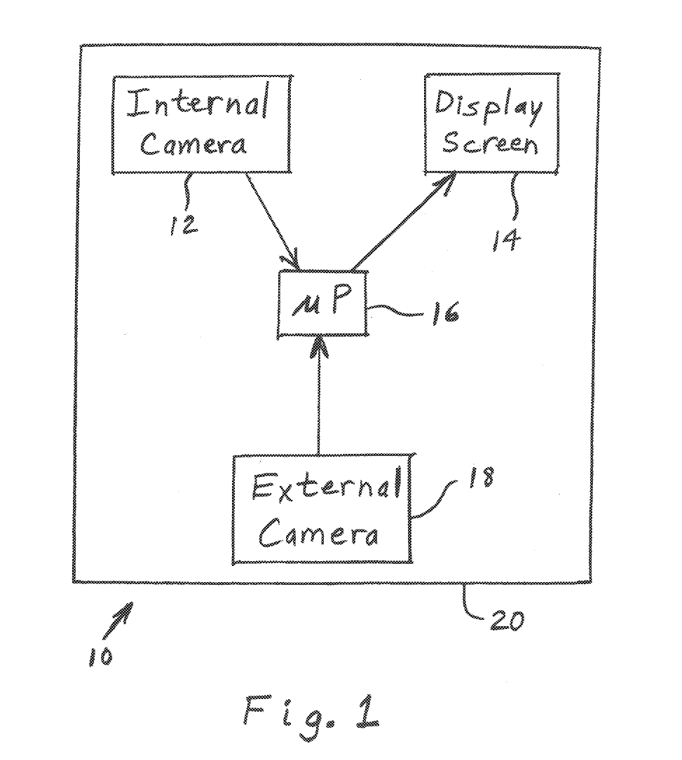

FIG. 1 illustrates one embodiment of a rearview display arrangement 10 of the present invention, including an internal camera 12, a display screen 14, an electronic processor 16, and an external camera 18, all of which may be disposed within a same motor vehicle 20. Internal camera 12 may be directed into the passenger compartment of vehicle 20, and may be disposed on a visor or near the top edge of the windshield. Internal camera 12 may capture images of a human driver of vehicle 20, and these captured images may be used by processor 16 to monitor the positions and movements of the eyes of the driver.

External camera 18 may be attached to a rear end of vehicle 20, and may capture images of a scene behind vehicle 20. External camera 18 may have a field of view similar to the field of view of a conventional rearview mirror.

Processor 16 may receive the images captured by external camera 18, and present a portion of a mirror image of each of the images on display screen 14. A mirror image of the captured image is presented in order to emulate the view that a driver would see in a conventional mirror. The portions of the mirror images of the captured images that are displayed on screen 14 may vary depending upon the locations of the driver's eyes, as determined by processor 16. Processor 16 may determine the positions of the driver's eyes based on the images captured by internal camera 12. Although it is possible for display screen 14 to have a generally isosceles trapezoidal shape, as a conventional rearview mirror might, it is also possible for display screen 14 and the presented portion of the externally captured images to be rectangular in shape.

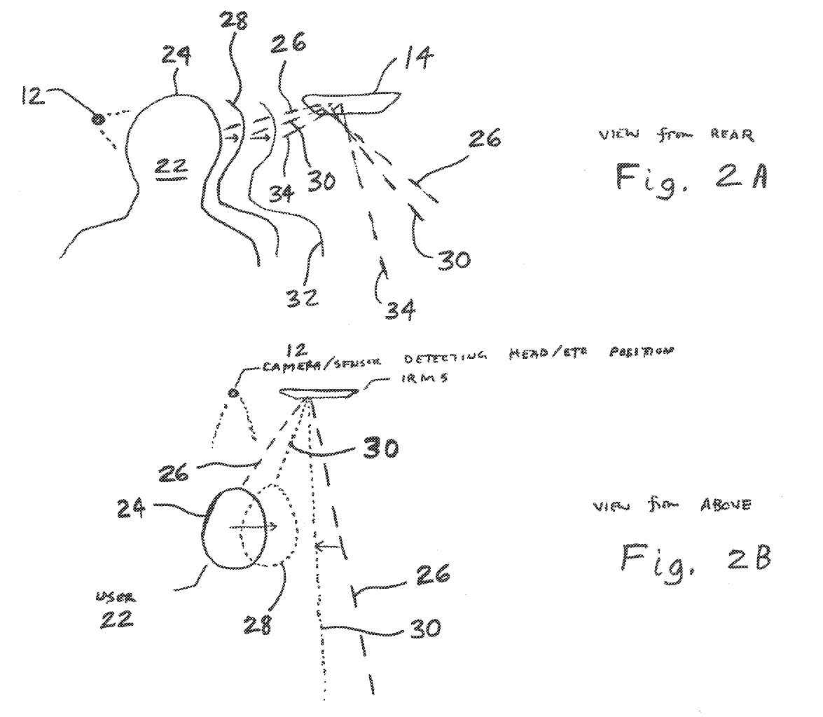

FIG. 2A is a frontward view inside a passenger compartment of motor vehicle 20. Internal camera 12 may be disposed slightly above the eye level of driver 22, and may capture images of a face of driver 22 as he looks at display screen 14. FIG. 2B is a downward view inside the passenger compartment of motor vehicle 20. Both FIG. 2A and FIG. 2B illustrate the changing angle of reflection that the driver would experience with a conventional mirror as he moves his head to the right. That is, with the driver's head in its original position, as indicated at 24, the angle of reflection is as indicated at 26. As driver 22 moves his head rightward from position 24 to the position indicated at 28, the angle of reflection, as indicated at 30, becomes smaller. Consequently, processor 16 may change the portion of the external image that is presented on display screen 14 to emulate the changing field of view provided by a conventional rearview mirror as the driver moves his head and eyes, as determined by processor 16 based on the images captured by internal camera 12. As driver 22 continues to move his head rightward to the position indicated at 32, the angle of reflection, as indicated at 34, becomes still smaller.

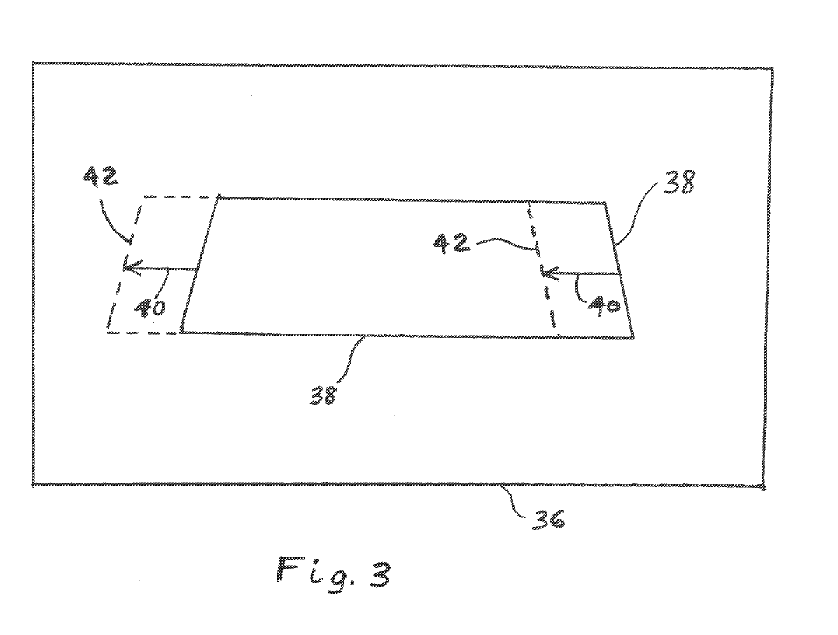

FIG. 3 illustrates a mirror image 36 of a field of view of external camera 18, and the portion 38 of the mirror image 36 of the field of view that is displayed on display screen 14. External camera 18 may capture images of the entire field of view, but processor 16 may transmit a video signal to display screen 14 that includes only portion 38. The video signal may include mirror images of the actual captured images to emulate the reflection of a conventional mirror.

As driver 22 moves his head rightward from position 24 to position 28, processor 16 may shift displayed portion 38 of mirror image 36 of the field of view leftward, as indicated by arrows 40, and by the dashed lines 42 indicating the shifted position of portion 38. The leftward movement of portion 38 in response to the rightward movement of the eyes of driver 22 emulates the changing view that a driver would see in a conventional mirror. Conversely, if driver 22 were to move his head leftward, portion 38 would shift rightward. Further, if driver 22 were to move his head upward, portion 38 would shift downward; and if driver 22 were to move his head downward, portion 38 would shift upward.

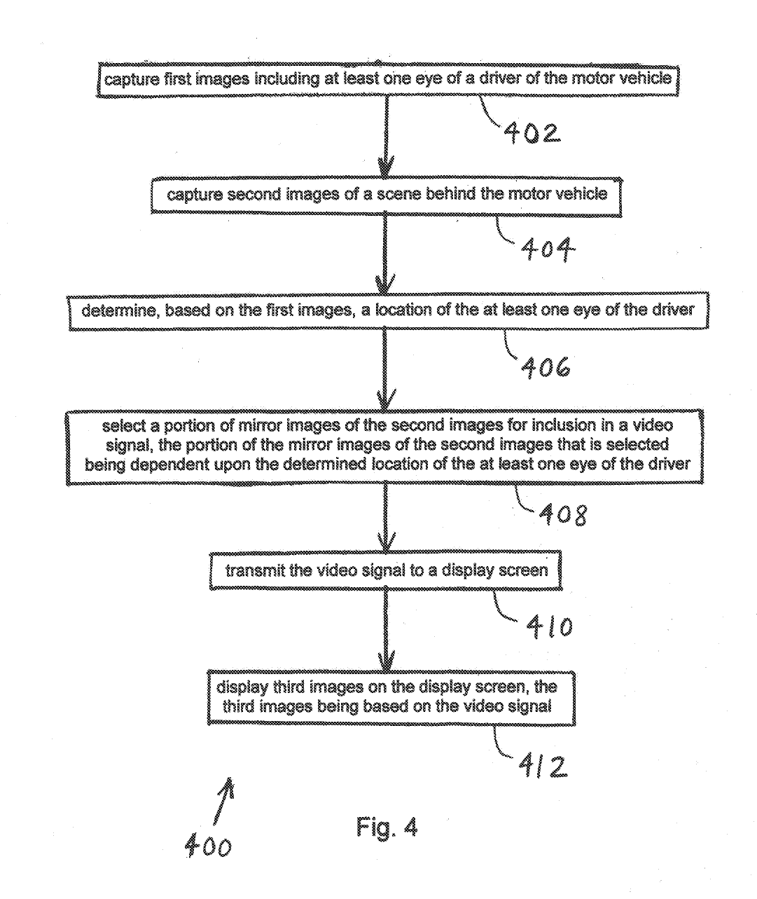

FIG. 4 illustrates one embodiment of a method 400 of the present invention for providing a display in a motor vehicle. In a first step 402, first images are captured including at least one eye of a driver of the motor vehicle. For example, an internal camera 12 may be disposed slightly above the eye level of driver 22 of motor vehicle 20, and may capture images of a face of driver 22, including his eyes, as he looks at display screen 14.

Next, in step 404, second images of a scene behind the motor vehicle are captured. For example, an external camera 18 may be attached to a rear end of vehicle 20, and may capture images of a scene behind vehicle 20.

In a next step 406, a location of the at least one eye of the driver is determined based on the first images. For example, processor 16 may determine the positions of the driver's eyes based on the images captured by internal camera 12.

In step 408, a portion of mirror images of the second images is selected for inclusion in a video signal. The portion of the mirror images of the second images that is selected is dependent upon the determined location of the at least one eye of the driver. For example, processor 16 may change the portion of the external image that is presented on display screen 14 to emulate the changing field of view provided by a conventional rearview mirror as the driver moves his head and eyes, as determined by processor 16 based on the images captured by internal camera 12.

Next, in step 410, the video signal is transmitted to a display screen. For example, processor 16 may transmit a video signal to display screen 14 that includes only portion 38.

In a final step 412, third images are displayed on the display screen. The third images are based on the video signal. For example, display screen 14 may display images based on the video signal transmitted by processor 16.

In another embodiment, a user-selectable mode can change the motion-view mapping (contrary to the way normal mirrors work). For instance, a rightward motion of the head may cause the portion 38 of the mirror image 36 of the field of view to move rightward (instead of leftward); a leftward motion of the head may cause the portion 38 of the mirror image 36 of the field of view to move leftward; an upward motion of the head may cause the portion 38 of the mirror image 36 of the field of view to move upward; and a downward motion of the head may cause the portion 38 of the mirror image 36 of the field of view to move downward.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A motor vehicle comprising:
an internal camera configured to capture first images including at least one eye of a driver of the motor vehicle;
an external camera configured to capture second images, the second images being of a scene behind the motor vehicle;
an electronic processor communicatively coupled to both the internal camera and the external camera, the electronic processor being configured to:
determine, based on the first images, a location of the at least one eye of the driver, and
transmit a video signal representing a selected portion of mirror images of the second images, the portion of the mirror images of the second images that is selected for representation by the video signal being dependent upon the determined location of the at least one eye of the driver; and
a display screen communicatively coupled to the electronic processor and configured to display third images, the third images being based on the video signal.

2. The motor vehicle of claim 1, wherein the electronic processor is configured to estimate, based on the first images, a location of the at least one eye of the driver relative to the display screen.

3. The motor vehicle of claim 2, wherein the portion of the mirror images of the second images that is selected for representation by the video signal is dependent upon the estimated location of the at least one eye of the driver relative to the display screen.

4. The motor vehicle of claim 1 wherein, in response to the driver's eye moving in a rightward direction, and in order to emulate the same response that would occur with an actual mirror reflection, the portion of the mirror images of the second images that is selected for representation by the video signal moves in a leftward direction relative to the mirror images of the second images.

5. The motor vehicle of claim 1, wherein, in response to the driver's eye moving, the portion of the mirror images of the second images is selected to emulate a view of the driver in a conventional rearview mirror as the driver's eye moves.

6. The motor vehicle of claim 1 wherein the display screen is disposed approximately at a midpoint of a top edge of a windshield of the motor vehicle.

7. The motor vehicle of claim 1 wherein the external camera is attached to a rear end of the motor vehicle.

8. A method of providing a display in a motor vehicle, the method comprising:
capturing first images including at least one eye of a driver of the motor vehicle;
capturing second images of a scene behind the motor vehicle;
determining, based on the first images, a location of the at least one eye of the driver;
selecting a portion of mirror images of the second images for inclusion in a video signal, the portion of the mirror images of the second images that is selected being dependent upon the determined location of the at least one eye of the driver;
transmitting the video signal to a display screen; and
displaying third images on the display screen, the third images being based on the video signal.

9. The method of claim 8, wherein the determining step includes determining, based on the first images, a location of the at least one eye of the driver relative to the display screen.

10. The method of claim 9, wherein the portion of the mirror images of the second images that is selected for representation by the video signal is dependent upon the determined location of the at least one eye of the driver relative to the display screen.

11. The method of claim 8 wherein, in response to the driver's eye moving in an upward direction, the portion of the mirror images of the second images that is selected for representation by the video signal moves in a downward direction relative to the mirror images of the second images.

12. The method of claim 8, wherein, in response to the driver's eye moving, the portion of the mirror images of the second images is selected to emulate a view of the driver in a conventional rearview mirror as the driver's eye moves.

13. The method of claim 8 wherein the display screen is disposed approximately at a midpoint of a top edge of a windshield of the motor vehicle

14. The method of claim 8 wherein the second images are captured by an external camera attached to a rear end of the motor vehicle.

15. A motor vehicle comprising:
an internal camera configured to capture first images including a head of a driver of the motor vehicle;
an external camera configured to capture second images, the second images being of a scene behind the motor vehicle;
an electronic processor communicatively coupled to both the internal camera and the external camera, the electronic processor being configured to:
determine, based on the first images, a location of the head of the driver; and
transmit a video signal based on a selected portion of the second images, the portion of the second images that is selected being dependent upon the determined location of the head of the driver; and
a display screen communicatively coupled to the electronic processor and configured to display third images, the third images being based on the video signal.

16. The motor vehicle of claim 15, wherein the electronic processor is configured to determine, based on the first images, a location of the head of the driver relative to the display screen.

17. The motor vehicle of claim 16, wherein the portion of the second images on which the video signal is based is selected dependent upon the determined location of the head of the driver relative to the display screen.

18. The motor vehicle of claim 15 wherein, in response to the driver's head moving in a leftward direction, the portion of the second images on which the video signal is based moves in a leftward direction relative to the second images.

19. The motor vehicle of claim 15, wherein, in response to the driver's head moving, the portion of the second images is selected to emulate a view of the driver in a conventional rearview mirror as the driver's head moves.

20. The motor vehicle of claim 15 wherein the display screen is disposed approximately at a midpoint of a top edge of a windshield of the motor vehicle.

21. The motor vehicle of claim 15 wherein the external camera is attached to a rear end of the motor vehicle.
